(19) United States
(12) Patent Application Publication
(10) Pub. No.: US 2025/0103255 A1
(43) Pub. Date: Mar. 27, 2025

(54) IMAGE FORMING APPARATUS AND CONTROL METHOD

(71) Applicant: CANON KABUSHIKI KAISHA, Tokyo (JP)

(72) Inventor: SEIJIRO IMAI, Ibaraki (JP)

(21) Appl. No.: 18/884,394

(22) Filed: Sep. 13, 2024

(30) Foreign Application Priority Data
Sep. 25, 2023 (JP) 2023-159979

(51) Int. Cl. G06F 3/12; G06T 7/00; G06T 7/90

(52) U.S. Cl. CPC G06F 3/1234; G06F 3/121; G06T 7/0004; G06T 7/90; G06T 2207/10008; G06T 2207/10024; G06T 2207/30144

(57) ABSTRACT

Even in a case where a print job is interrupted, whether there is a periodic image defect over a plurality of scanned images is determined. An image forming apparatus according to the present disclosure acquires data on a scanned image obtained by reading a printing material on which a pattern image is formed, detects a periodic image defect from the data, identifies a component of an image forming apparatus that has caused the image defect based on a period of the detected image defect, and in a case where a job of forming the pattern image on a plurality of printing materials is interrupted, resumes forming the pattern image from the beginning of the job.

### BACKGROUND

### Field

The present disclosure relates to an image diagnosis technique in image formation.

### Description of the Related Art

There is a technique for using data on an image (hereinafter referred to as “scanned image”) obtained by reading printed material output from an image forming apparatus to detect defects in image formation (hereinafter referred to as “printing”) using the image forming apparatus. For example, image processing is performed on a scanned image, and data on the scanned image after image processing (hereinafter referred to as “processed scanned image”) is compared with original scanned image data to detect defects such as stains, white spots, or skew in printing. Such defects in printing may occur due to a deterioration in a component in the image forming apparatus caused by using the image forming apparatus under stress for a long period of time or the like. In order to facilitate detecting such phenomena of defects in printing, there is also an image diagnosis technique for identifying the phenomenon of a printing defect and a factor in occurrence of the phenomenon by printing a dedicated chart for image diagnosis (hereinafter referred to as “diagnostic chart” or pattern image) and reading the chart using an image sensor or the like.

There are some image diagnoses in which a consumable part having an abnormality is identified from components in an image forming apparatus based on a periodic printing defect that occurs in a scanned image. For example, in a case where an abnormality such as a scratch occurs on the outer circumference of a rotation part (consumable part) involved in printing, such as a photosensitive drum, a transfer drum, or an intermediate transfer belt, an image defect such as a streak-like image defect or a dot-like image defect caused by the abnormality occurs in the scanned image every time the rotation part rotates once. That is, in this case, an image defect occurs in a regular period in the scanned image. Based on such a characteristic, it is determined in the image diagnosis that in a plurality of scanned images obtained by reading a plurality of diagnostic charts output in succession, whether a periodic image defect occurs across a plurality of scanned images in consideration of intervals between the scanned images. In a case where a periodic image defect is detected, a rotation part that causes the image defect may be identified by identifying the period of the image defect and comparing the identified period of the image defect with the rotation period of each rotation part.

Japanese Patent Laid-Open No. 2020-170115 discloses a technique for continuing a diagnostic chart print job (hereinafter referred to as “chart print job”) even in a case where an image defect is detected in a scanned image in image diagnosis during the chart print job, that is, even in a case where an abnormality in an image forming apparatus is detected. According to the technique disclosed in Japanese Patent Laid-Open No. 2020-170115, an abnormality in another rotation part other than the abnormality may also be identified.

During the chart print job, in a case where the print job is interrupted due to a factor such as paper jamming (hereinafter referred to as “paper jam”), it may be difficult to detect an image defect with periodicity. This is because a rotation part is rotated due to a preliminary operation before the resumption of the chart print job, and the continuity of the rotation of the rotation part in a series of print jobs is interrupted between a state where the chart print job is interrupted and a state where the chart print job is resumed. Japanese Patent Laid-Open No. 2020-170115 does not disclose an operation in a case where the chart print job is interrupted during the chart print job. Thus, in the technique disclosed in Japanese Patent Laid-Open No. 2020-170115, there is a problem in that in a case where the chart print job for determining the presence or absence of periodicity in an image defect is interrupted and then resumed, it may not be possible to determine the presence or absence of a periodic image defect across a plurality of scanned images.

The present disclosure is for solving the above problem and aims to provide a technique capable of determining the presence or absence of a periodic image defect across a plurality of scanned images even in a case where a print job is interrupted.

### SUMMARY

An image processing apparatus according to the present disclosure comprises an image forming unit configured to form a pattern image on a printing material, the image processing apparatus comprising: one or more controllers including one or more processors; and one or more memories, the one or more controllers configured to: acquire data on a scanned image obtained by reading the printing material on which the pattern image is formed; detect a periodic image defect from the data; identify a component of the image forming apparatus that has caused the image defect based on a period of the detected image defect; and in a case where a job of forming the pattern image on a plurality of printing materials is interrupted, resume forming the pattern image from a beginning of the job.

Further features of the present disclosure will become apparent from the following description of exemplary embodiments (with reference to the attached drawings).

### BRIEF DESCRIPTION OF THE DRAWINGS

FIG. 1 is a diagram showing an example of a configuration of an image forming system;

FIG. 2 is a block diagram showing an example of a hardware configuration of each device of an image forming apparatus, an external controller, and a user terminal;

FIG. 3 is a diagram showing an example of a cross section of the image forming apparatus;

FIGS. 4A and 4B are diagrams showing examples of inspection result check screens;

FIG. 5 is a diagram showing an example of a period list;

FIGS. 6A to 6D are diagrams showing examples of screens relating to image diagnosis;

FIGS. 7A to 7E are diagrams showing examples of screens displayed during execution of an image diagnosis job;

FIG. 8 is a block diagram showing an example of a functional configuration of an inspection device;

FIG. 9 is a flowchart showing an example of a processing flow in the inspection device; and

FIG. 10 is a flowchart showing an example of the flow of a process of resuming the image diagnosis job in the inspection device.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

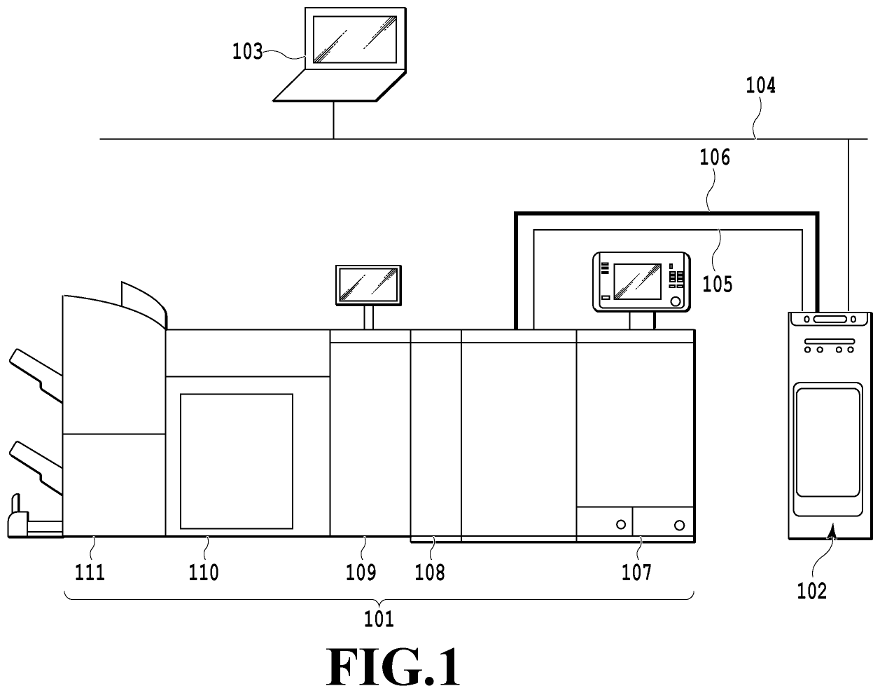

FIG. 1 is a diagram showing an example of a configuration of an image forming system according to a first embodiment. The image forming system includes an image forming apparatus 101, an external controller 102, and a user terminal 103. The image forming apparatus 101 and the external controller 102 are communicably connected to each other via an internal LAN 105 and a video cable 106. The external controller 102 is communicably connected to the user terminal 103 via an external LAN 104 and receives a print instruction from the user terminal 103.

The user terminal 103 includes a personal computer and the like, and a printer driver having the function of converting print data into a print description language processable by the external controller 102 is installed in the user terminal 103. By operating the user terminal 103, a user may give a print instruction via a printer driver from various applications installed in the user terminal 103. The printer driver transmits print data as a print instruction to the external controller 102 based on the print instruction from the user.

In a case where the external controller 102 receives a print instruction from the user terminal 103, the external controller 102 performs processing such as data analysis processing and rasterizing processing on the print data and transmits a print job to the image forming apparatus 101. Specifically, the external controller 102 transmits the print job to the image forming apparatus 101 via the internal LAN 105 and transmits, via the video cable 106, image data obtained after rasterizing the print data. The external controller 102 is also referred to as image processing controller, digital front end (DFE), print server, or the like.

The image forming apparatus 101 includes a plurality of devices having different functions and is configured to be capable of performing complex print processing such as printing for bookbinding. The image forming apparatus 101 is also referred to as composite machine or multifunction peripheral (MFP). In the present embodiment, it is assumed that the image forming apparatus 101 includes a printing device 107, an inserter 108, an inspection device 109, a large-capacity stacker 110, and a finisher 111. The printing device 107 performs image forming (printing) using toner on a sheet conveyed from a feeding unit arranged at the lower portion of the printing device 107 or the like, based on the print job received from the external controller 102 and the image data after rasterizing processing. It should be noted that in the present embodiment, it is assumed that an image is formed on a sheet. However, targets for image forming are not limited to sheets, but may be print media other than sheets.

The configuration and operation principle of the printing device 107 are as follows. First, the printing device 107 irradiates a rotating polygon mirror such as a polygon mirror with a light beam such as a laser beam modulated according to received image data and irradiates a photosensitive drum with reflected light from the rotating polygon mirror as a scanning beam.

An electrostatic latent image is formed on the surface of the photosensitive drum with this scanning beam, the formed electrostatic latent image is developed with toner, and a toner image is formed on the surface of the photosensitive drum. The toner image formed on the surface of the photosensitive drum is transferred to a sheet attached to a transfer drum. The printing device 107 sequentially executes a series of printing steps as described above for yellow (Y) toner, magenta (M) toner, cyan (C) toner, and black (K) toner, thereby forming a full-color image on the sheet. The sheet on which the full-color image has been formed on the transfer drum is conveyed to a fixing device. The fixing device includes a roller, a belt, and the like, and the roller has a built-in heat source such as a halogen heater. The fixing device melts the toner on the sheet to which the toner image has been transferred by heat and pressure and fixes the toner to the sheet.

The inserter 108 is a device for inserting an insertion sheet. The inserter 108 may insert a sheet (insertion sheet) into a group of sheets (hereinafter referred to as “printed material”) after image formation conveyed from the printing device 107 in a predetermined position or at a predetermined time. The inspection device 109 is a device for determining whether an image formed on printed material is normal. Specifically, the inspection device 109 reads printed material conveyed from the printing device 107 via the inserter 108 and compares scanned image data obtained by the reading with reference image data registered in advance. In this manner, the inspection device 109 determines whether an image formed on printed material is normal. Hereinafter, this determination processing will be referred to as inspection processing. For example, the inspection device 109 separates printed materials into printed materials determined to be normal and printed materials determined to be abnormal, i.e., to have an image defect, based on the result of the determination (hereinafter referred to as “inspection result”) and conveys and discharges the printed materials.

The large-capacity stacker 110 is a device capable of stacking a large amount of printed materials. The finisher 111 is a device that performs finishing processing on conveyed printed material. The finisher 111 may perform finishing processing such as stapling processing, punching, and saddle-stitch bookbinding processing in accordance with a given setting. Printed material that has been finished by the finisher 111 is discharged to a discharge tray.

The image forming system shown as an example in FIG. 1 includes the external controller 102 through which the image forming apparatus 101 and the user terminal 103 are connected. However, the image forming system does not have to include the external controller 102. For example, the image forming apparatus 101 and the user terminal 103 may be connected via the external LAN 104, and the user terminal 103 may transmit print data processable by the image forming apparatus 101. In this case, for example, the image forming apparatus 101 performs processing such as data analysis processing and rasterizing processing on print data received from the user terminal 103 in place of the external controller 102, and then performs print processing.

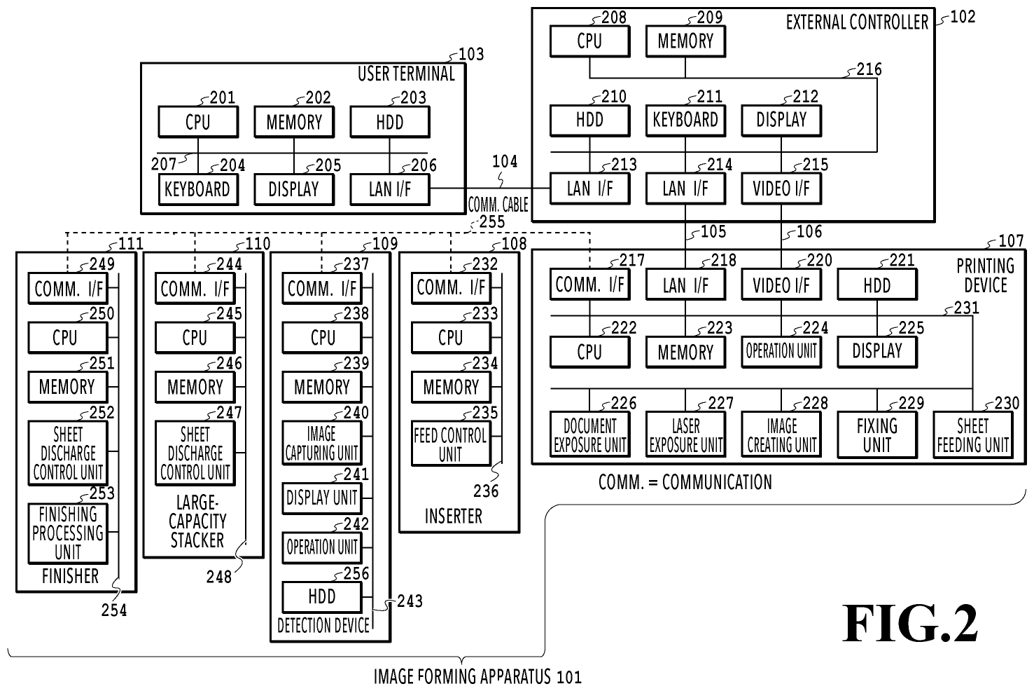

FIG. 2 is a block diagram showing an example of the hardware configuration of each device of the image forming apparatus 101, the external controller 102, and the user terminal 103 according to the first embodiment. First, the hardware configuration of the printing device 107 of the image forming apparatus 101 will be described. The printing device 107 includes, as hardware constituents, a communication I/F 217, a LAN I/F 218, a video I/F 220, an HDD 221, a CPU 222, a memory 223, an operation unit 224, and a display 225. In addition to the above constituents, the printing device 107 includes, as hardware constituents, a document exposure unit 226, a laser exposure unit 227, an image creating unit 228, a fixing unit 229, and a sheet feeding unit 230. The hardware constituents of the printing device 107 are communicably connected to each other via a system bus 231.

The communication I/F 217 is connected to the inserter 108, the inspection device 109, the large-capacity stacker 110, and the finisher 111 via a communication cable 255 and transmits and receives a control signal and the like for controlling each device. The LAN I/F 218 is connected to the external controller 102 via the internal LAN 105 and transmits and receives print data and the like. The video I/F 220 is connected to the external controller 102 via the video cable 106 and transmits and receives data on a rasterized image and the like.

The HDD 221 is a storage device that stores a program, data, and the like. The CPU 222 reads out a program or the like stored in the HDD 221 and expands the program or the like into the memory 223, and comprehensively controls various processes such as image processing and print processing in the printing device 107 based on the program. The memory 223 temporarily stores a program, image data, or the like required in a case where the CPU 222 performs various processes, and operates as a work area for the CPU 222. The operation unit 224 includes a touch sensor and the like and accepts input of various settings or operation instructions from a user. The display 225 includes a liquid crystal display and the like and displays information indicating settings on the image forming apparatus 101, the processing status of a print job, and the like. The CPU 222 also operates as an operation control unit that controls the operation unit 224 and a display control unit that controls the display 225.

The document exposure unit 226 reads a document in copying or reading the document. For example, the document exposure unit 226 reads a document by capturing the document with an image sensor such as a charge coupled device (CCD) while irradiating the document placed by a user with light from an exposure lamp. The laser exposure unit 227 is a device for irradiating a photosensitive drum with a light beam in forming an electrostatic latent image on the surface of the photosensitive drum. The laser exposure unit 227 first charges the surface of the photosensitive drum at a uniform negative potential (primary charging). Next, the laser exposure unit 227 irradiates the photosensitive drum with a light beam such as a laser beam from a laser driver while adjusting a reflection angle in a polygon mirror. As a result, the negative potential of a portion, of the surface of the photosensitive drum, irradiated with the light beam is neutralized, and an electrostatic latent image is formed. The CPU 222 also operates as a reading control unit that controls the document exposure unit 226 and an exposure control unit that controls the laser exposure unit 227.

The image creating unit 228 is a device for attaching toner to the surface of the photosensitive drum to develop a toner image and transfer the developed toner image to a sheet. The image creating unit 228 includes a developing unit, a transfer unit, a toner supply unit, and the like not shown in FIG. 2. The developing unit attaches toner charged at a negative potential from a developing cylinder to an electrostatic latent image formed on the surface of the photosensitive drum, develops a toner image, and visualizes the electrostatic latent image. The transfer unit performs primary transfer in which a positive potential is applied to a primary transfer roller to transfer the toner attached to the surface of the photosensitive drum to the transfer belt and secondary transfer in which a positive potential is applied to a secondary transfer outer roller to transfer the toner transferred to the transfer belt to a sheet. The fixing unit 229 includes a heater such as a halogen heater, a fixing belt, a pressure belt, and the like not shown in FIG. 2, and melts and fixes the toner transferred to the surface of the sheet to the sheet by heat and pressure. The sheet feeding unit 230 is a device for feeding sheets, and a sheet feeding operation and a sheet conveying operation are controlled with rollers and various sensors. The CPU 222 also operates as an image creation control unit that controls the image creating unit 228 and a feed control unit that controls the sheet feeding unit 230.

Next, the hardware configuration of the inserter 108 of the image forming apparatus 101 will be described. The inserter 108 includes, as hardware constituents, a communication I/F 232, a CPU 233, a memory 234, and a feed control unit 235. The hardware constituents of the inserter 108 are communicably connected to each other via a system bus 236. The communication I/F 232 is connected to the printing device 107 via the communication cable 255 and receives a control signal required for control. The CPU 233 performs various kinds of control required for feeding processing according to a control program stored in the memory 234. The memory 234 is a storage device that stores a control program and operates as a work area for the CPU 233. The feed control unit 235 controls the feed and conveyance of an insertion sheet and the conveyance of a sheet (printed material) conveyed from the printing device 107 while controlling the rollers and sensors based on instructions from the CPU 222.

Next, the configuration of the inspection device 109 of the image forming apparatus 101 will be described. The inspection device 109 includes, as hardware constituents, a communication I/F 237, a CPU 238, a memory 239, an image capturing unit 240, a display unit 241, an operation unit 242, and an HDD 256. The hardware constituents of the inspection device 109 are communicably connected to each other via a system bus 243.

The communication I/F 237 is connected to the printing device 107 via the communication cable 255 and transmits and receives information or a signal required for control. The communication cable 255 also receives reference image data used to inspect printed material from the printing device 107 via the communication I/F 237. The received reference image data is stored in the HDD 256. The CPU 238 reads out a control program stored in the HDD 256, expands the control program into the memory 239, and performs various kinds of control required for inspection processing according to the control program. The memory 239 operates as a work area for the CPU 238. It should be noted that a method for receiving reference image data is not limited to the above method. For example, the inspection device 109 may include a LAN I/F not shown in FIG. 2 and may receive reference image data from the external controller 102 by communicating with the external controller 102 via the LAN I/F and an internal LAN.

The image capturing unit 240 captures a sheet (printed material) conveyed from the printing device 107 via the inserter 108 based on an instruction from the CPU 238. The CPU 238 performs a process of determining (inspecting) whether an image formed on a sheet is normal by comparing image (scanned image) data obtained by image capturing by the image capturing unit 240 with reference image data stored in the HDD 256. The display unit 241 includes a liquid crystal display and the like and displays a screen showing the result of the above determination (inspection result) and settings for the determination and the like. The operation unit 242 includes a touch sensor and the like and accepts various kinds of input or operation instructions from a user, such as a change in settings of inspection conditions of the inspection device 109 and registration of reference image data. The CPU 238 also operates as an operation control unit that controls the operation unit 242 and a display control unit that controls the display unit 241. The HDD 256 is a storage device that stores a control program, reference image data, and the like. It should be noted that, although the inspection device 109 is described as including the HDD 256, the inspection device 109 does not have to include the HDD 256. For example, in this case, a control program and a received control program are stored in the memory 239.

Next, the configuration of the large-capacity stacker 110 of the image forming apparatus 101 will be described. The large-capacity stacker 110 includes, as hardware constituents, a communication I/F 244, a CPU 245, a memory 246, and a sheet discharge control unit 247. The hardware constituents of the large-capacity stacker 110 are communicably connected to each other via a system bus 248. The communication I/F 244 is connected to the printing device 107 via the communication cable 255 and transmits and receives information or a signal required for control. The CPU 245 performs various kinds of control required for sheet (printed material) discharge processing according to a control program stored in the memory 246. The memory 246 is a storage device that stores a control program and operates as a work area for the CPU 245. The sheet discharge control unit 247 performs control for conveying a conveyed sheet (printed material) to a stack tray, an escape tray, or the subsequent finisher 111 based on an instruction from the CPU 245.

Next, the configuration of the finisher 111 of the image forming apparatus 101 will be described. The finisher 111 includes, as hardware constituents, a communication I/F 249, a CPU 250, a memory 251, a sheet discharge control unit 252, and a finishing processing unit 253. The hardware constituents of the finisher 111 are communicably connected to each other via a system bus 254. The communication I/F 249 is connected to the printing device 107 via the communication cable 255 and transmits and receives information required for control. The CPU 250 performs various kinds of control required for finishing processing, sheet discharge processing, and the like according to a control program stored in the memory 251. The memory 251 is a storage device that stores a control program and operates as a work area for the CPU 250. The sheet discharge control unit 252 controls sheet (printed material) conveyance and discharge processing based on an instruction from the CPU 250. The finishing processing unit 253 controls various finishing processes such as stapling processing, punching, and saddle-stitch bookbinding processing based on an instruction from the CPU 250.

Next, the configuration of the external controller 102 will be described. The external controller 102 includes, as hardware constituents, a CPU 208, a memory 209, an HDD 210, a keyboard 211, a display 212, a LAN I/F 213, a LAN I/F 214, and a video I/F 215. The hardware constituents of the external controller 102 are communicably connected to each other via a system bus 216. The CPU 208 comprehensively executes various processes in the external controller 102, such as receiving print data from the user terminal 103, a raster image processor (RIP), and transmitting a print job to the image forming apparatus 101. Specifically, the CPU 208 reads out a program and data stored in the HDD 210, expands the program and data into the memory 209, and executes the processes based on the program and the like. The memory 209 is a storage device that temporarily stores programs and data required in a case where the CPU 208 performs various processes, and the memory 209 operates as a work area for the CPU 208. The HDD 210 is a storage device that stores programs and data required for operations such as print processing.

The keyboard 211 is an input device for a user to input an operation instruction to the external controller 102. The display 212 includes a liquid crystal display and the like and displays information indicating the state of an application executed by the external controller 102 or the like by using a video signal of a still image or a moving image. The CPU 208 also operates as an operation control unit that controls the keyboard 211 and a display control unit that controls the display 212. The LAN I/F 213 is connected to the user terminal 103 via the external LAN 104 and transmits and receives a print instruction and the like to and from the user terminal 103. The LAN I/F 214 is connected to the image forming apparatus 101 via the internal LAN 105 and transmits and receives a print job and the like to and from the image forming apparatus 101. The video I/F 215 is connected to the image forming apparatus 101 via the video cable 106 and transmits and receives image data after rasterizing processing and the like.

Next, the configuration of the user terminal 103 will be described. The user terminal 103 includes, as hardware constituents, a CPU 201, a memory 202, an HDD 203, a keyboard 204, a display 205, and a LAN I/F 206. The hardware constituents of the user terminal 103 are communicably connected to each other via a system bus 207. The CPU 201 reads out various programs such as a document processing program stored in the HDD 203, expands the programs into the memory 202, and executes various processes such as a process of creating print data and a process of transmitting a print instruction based on the programs. The CPU 201 also comprehensively controls the devices connected to each other via the system bus 207. The memory 202 is a storage device that temporarily stores programs and data required in a case where the CPU 201 performs various processes, and the memory 202 operates as a work area for the CPU 201. The HDD 203 is a storage device that stores programs and data required for operations such as print processing.

The keyboard 204 is an input device for a user to input an operation to the user terminal 103. The display 205 includes a liquid crystal display and the like and displays information indicating the state of an application executed by the user terminal 103 using a video signal of a still image or a moving image. The CPU 201 also operates as an operation control unit that controls the keyboard 204 and a display control unit that controls the display 205. The LAN I/F 206 is connected to the external controller 102 via the external LAN 104 and transmits and receives a print instruction and the like.

The external controller 102 and the image forming apparatus 101 are described above as being connected to each other via the internal LAN 105 and the video cable 106. However, a form of connection is not limited to the above configuration. The external controller 102 and the image forming apparatus 101 may be connected so that data required for printing may be transmitted and received and may be, for example, connected only via the video cable. Further, each of the memory 202, the memory 209, the memory 223, the memory 234, the memory 239, the memory 246, and the memory 251 may be a storage device for holding data or a program. For example, each of the memory 202, the memory 209, the memory 223, the memory 234, the memory 239, the memory 246, and the memory 251 may be replaced with a volatile RAM, a non-volatile ROM, an internal HDD, an external HDD, a USB memory, or the like.

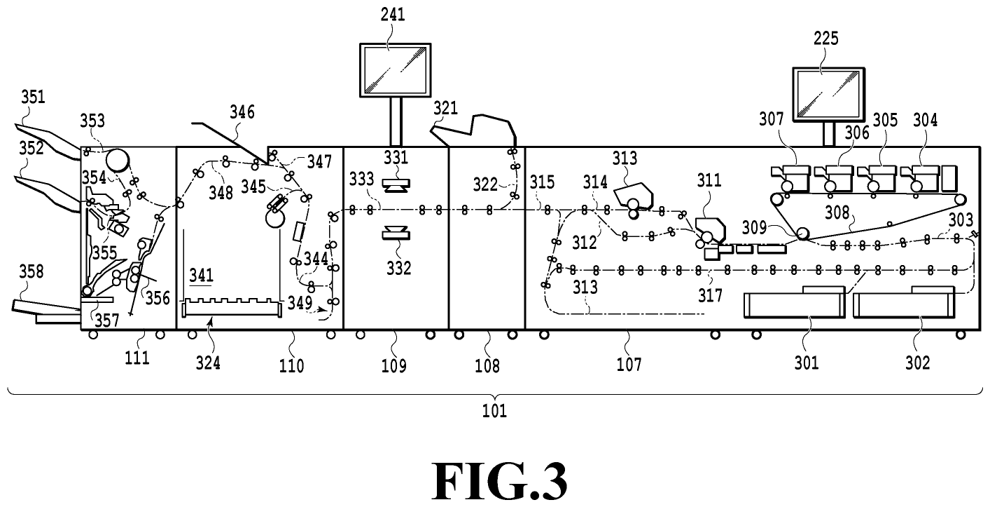

FIG. 3 is a diagram showing an example of a cross section of the image forming apparatus 101 according to the first embodiment. First, the printing device 107 of the image forming apparatus 101 will be described. The display 225 displays information indicating settings on the image forming apparatus 101, the processing status of a print job, and the like. Feed decks 301, 302 store various types of sheets before image formation. A user may set information indicating the sizes, types, and the like of sheets stored in the feed decks 301, 302 using the operation unit 224. Only the topmost sheet is separated from a sheet group accommodated in the feed deck 301 or 302 and is conveyed to a sheet conveyance path 303. Developing stations 304 to 307 form a toner image on the surface of a photosensitive drum using color toner of each color of Y, M, C, and K to form a color image. The toner image formed on the surface of the photosensitive drum is primarily transferred to an intermediate transfer belt 308 rotating clockwise in FIG. 3 and is transferred to the sheet conveyed through the sheet conveyance path 303 in a secondary transfer position 309.

A fixing unit 311 fixes the toner image to the sheet. The fixing unit 311 includes a pressure roller and a heat roller, and in a case where the sheet passes between these rollers, toner is melted and pressed to fix the transferred toner image to the sheet. The sheet (printed material) that has passed through the fixing unit 311 is conveyed to the sheet conveyance path 315 through the sheet conveyance path 312. Depending on the type of sheet, there is a case where the toner must be melted and pressed again to be fixed to the sheet. In such a case, after passing through the fixing unit 311, the sheet (printed material) is conveyed to a second fixing unit 313 using a sheet conveyance path 314. While the sheet (printed material) passes through the second fixing unit 313, additional melting and pressing are performed.

After passing through the second fixing unit 313, the sheet (printed material) is conveyed to the sheet conveyance path 315 through the sheet conveyance path 314. In a case where a double-sided printing mode is selected as a printing mode, the sheet (printed material) is conveyed to a sheet inversion path 316 before being conveyed to the sheet conveyance path 315, and after being inverted in the sheet inversion path 316, the sheet (printed material) is conveyed to the sheet conveyance path 303 via a double-sided conveyance path 317. After that, the sheet (printed material) passes through the above paths again, and transfer to a second side is made in the secondary transfer position 309.

The inserter 108 inserts an insertion sheet into a printed material group in a predetermined position or at a predetermined time. The inserter 108 includes an inserter tray 321 and merges the insertion sheet arranged on the inserter tray 321 via a sheet conveyance path 322 into a conveyance path through which printed materials are conveyed. As a result, the insertion sheet is inserted into any position in a series of sheets (printed materials) conveyed from the printing device 107 and may be conveyed to a subsequent device. The printed materials and insertion sheet that have passed through the inserter 108 are conveyed to the inspection device 109.

In the inspection device 109, a camera 331 and a camera 332 are arranged so as to face each other. The camera 331 is for reading (capturing) the upper surface of printed material, and the camera 332 is for reading (capturing) the lower surface of printed material. At the time of printed material conveyed to the sheet conveyance path 333 reaching a predetermined position, the inspection device 109 reads an image formed on the printed material using the camera 331 and camera 332 to determine whether the image is normal (inspection processing). The display unit 241 displays the result of the determination made by the inspection device 109 (inspection result) and the like.

The large-capacity stacker 110 includes a stack tray 341 loaded with a sheet (printed material) determined to be normal by the inspection device 109. The sheet determined to be normal by the inspection device 109 is conveyed to the large-capacity stacker 110 through a sheet conveyance path 344. The conveyed sheet is loaded on the stack tray 341 via the sheet conveyance path 344 and a sheet conveyance path 345. The large-capacity stacker 110 also includes an escape tray 346 to which a sheet (printed material) determined to be abnormal by the inspection device 109 is discharged. The sheet determined to be abnormal by the inspection device 109 is conveyed to the large-capacity stacker 110 through the sheet conveyance path 344. The conveyed sheet is conveyed to the escape tray 346 via the sheet conveyance path 344 and a sheet conveyance path 347.

In a case where the large-capacity stacker 110 conveys a sheet (printed material) to a device in the rear stage of the large-capacity stacker 110, the sheet is conveyed to the device in the rear stage through a sheet conveyance path 348. An inversion unit 349 is a conveyance path for inverting the front and back of the sheet. The inversion unit 349 is used in the case of loading the stack tray 341 with a sheet, and in the case of loading the stack tray 341 with the sheet so that the orientation of the conveyed sheet matches the orientation of the sheet at the time of output, the inversion unit 349 inverts the sheet. In the case of conveying a sheet to the escape tray 346 or a subsequent device, since the sheet is discharged without being inverted, no inversion operation is performed by the inversion unit 349.

The finisher 111 performs finishing processing such as stapling processing, punching, and saddle-stitch bookbinding processing on a conveyed sheet in accordance with a setting previously designated by a user or the like. Specifically, the finisher 111 performs finishing processing such as stapling in one or two positions, punching of two or three holes, or saddle-stitch bookbinding processing. The finisher 111 includes a sheet discharging tray 351 and a sheet discharging tray 352. A sheet is discharged to the sheet discharging tray 351 via a sheet conveyance path 353. However, finishing processing such as stapling processing is not performed on a sheet (printed material) passing through the sheet conveyance path 353. In the case of performing finishing processing such as stapling processing, a sheet (printed material) passes through a sheet conveyance path 354, finishing processing set in advance by a user or the like is executed by a processing unit 355, and the sheet after the finishing processing is discharged to the sheet discharging tray 352.

The sheet discharging trays 351 and 352 may be raised and lowered individually, and the sheet discharging tray 351 may also be lowered and loaded with a sheet after finishing processing by the processing unit 355. In a case where the saddle-stitch bookbinding processing is set, a saddle-stitch bookbinding unit 356 staples sheets at the center and then folds the sheets in two to perform saddle-stitch bookbinding. The sheets after the saddle-stitch bookbinding processing (hereinafter referred to as “saddle-stitched printed materials”) are output to a saddle-stitch bookbinding tray 358 via a sheet conveyance path 357. The saddle-stitch bookbinding tray 358 has a belt conveyor structure, and a stack of the saddle-stitched printed materials loaded on the saddle-stitch bookbinding tray 358 is conveyed to the left in FIG. 3.

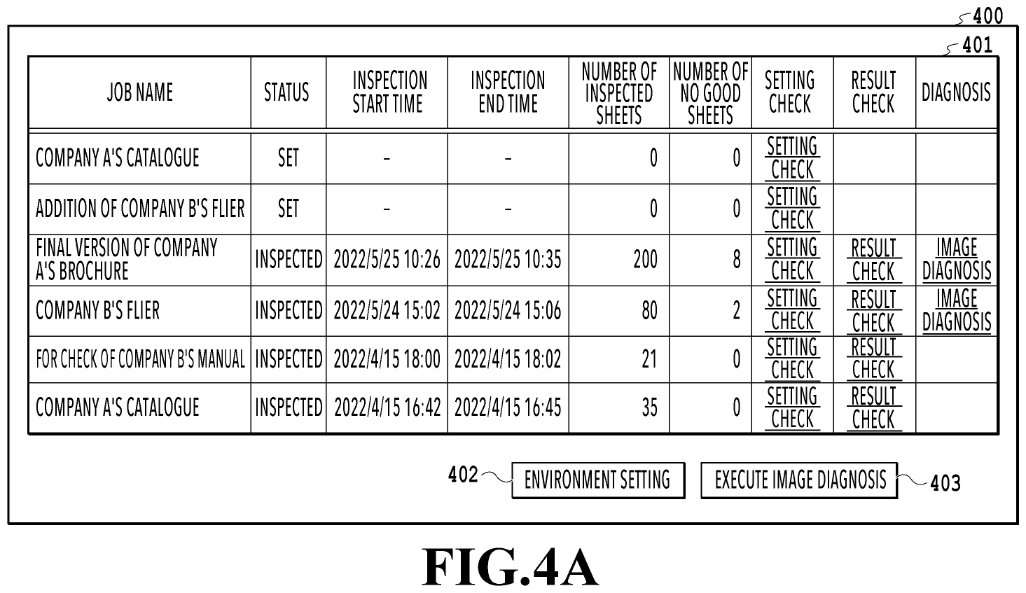

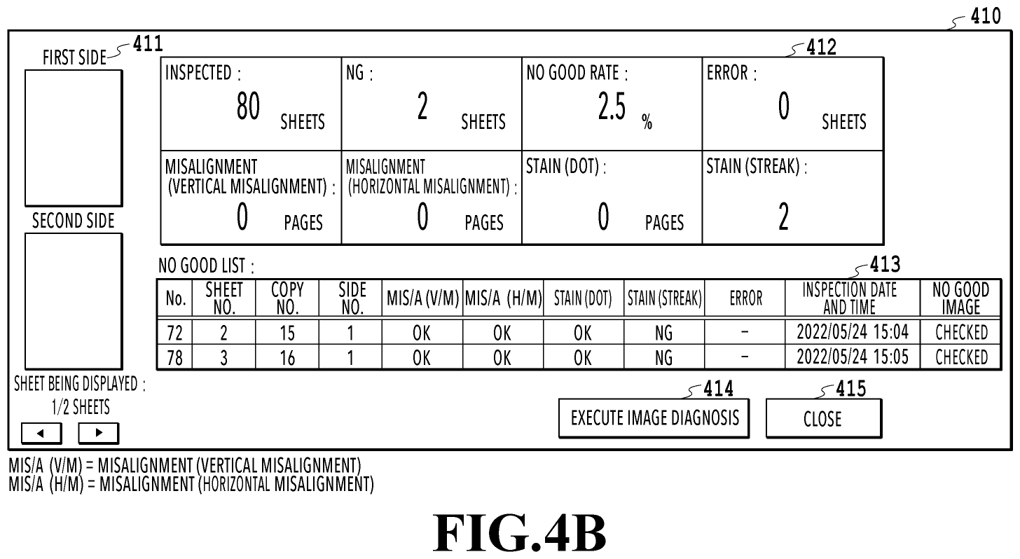

FIGS. 4A and 4B is a diagram showing an example of an inspection result check screen displayed on the display unit 241 by the inspection device 109 according to the first embodiment. Hereinafter, it is assumed that a check screen is displayed on the display unit 241, but the display output destination of the check screen is not limited to the display unit 241. For example, the check screen may be displayed on the display 225 of the printing device 107, the display 212 of the external controller 102, or the like. FIG. 4A shows an example of a check screen (hereinafter referred to as “list screen 400”) on which a list of inspection results is displayed. The list screen 400 includes an inspection result list 401, an environment setting button 402, and an image diagnosis execution button 403.

The inspection result list 401 displays, for example, a list of results of all inspection jobs registered in advance. Specifically, the inspection result list 401 displays information indicating the name of each inspection job (hereinafter referred to as “job name”), a status indicating the execution status of the inspection job, an inspection start time, and an inspection end time, which may identify the inspection job. In addition to the above information, the inspection result list 401 displays information indicating the number of sheets of inspected printed materials and the number of sheets of printed materials determined to be abnormal (hereinafter referred to as “NO GOOD”). Further, in addition to the above information, the inspection result list 401 displays information indicating a setting check link for checking the settings of the selected inspection job and transitioning to a screen not shown in FIGS. 4A and 4B. Furthermore, in addition to the above information, the inspection result list 401 displays information indicating a result check link for transitioning to a detailed check screen 410, which will be described later with reference to FIG. 4B, where a detailed inspection result may be checked. In addition, the inspection result list 401 displays information indicating an image diagnosis link for transitioning to an execution screen not shown in FIGS. 4A and 4B for executing image diagnosis based on the inspection result.

The inspection result list 401 includes an inspection job that has already been inspected (hereinafter referred to as “inspected job”) and an inspection job that has been registered but has not yet been inspected (hereinafter referred to as “uninspected job”). The status of an inspected job is denoted by “inspected,” and information indicating an inspection start time, an inspection end time, the number of sheets of inspected printed materials, and the number of sheets of printed materials determined to be “NO GOOD” is displayed. Further, in addition to the above items, information, on the inspected job, indicating a link for transitioning to the detailed check screen 410 is described. The inspection result list 401 also displays information indicating an image diagnosis link on an inspection job for which it is determined that it is better if image diagnosis of printed materials is performed out of inspection jobs including printed material determined to be “NO GOOD.” The status of an uninspected job is denoted by “set,” and an item other than the setting check link among the other items is blank or displays a predetermined value indicating that inspection has not yet been performed.

The environment setting button 402 is a user interface (UI) component for displaying an environment setting screen not shown in FIGS. 4A and 4B for setting environmental information on inspection processing in the image processing system, and the environment setting screen is displayed in a case where a user presses the environment setting button 402. The image diagnosis execution button 403 is a UI component for transitioning to an execution screen for executing image diagnosis, and the execution screen is displayed in a case where a user presses the image diagnosis execution button 403.

FIG. 4B shows an example of a detailed check screen 410 on which a detailed inspection result may be checked. Specifically, FIG. 4B shows an example of the detailed check screen 410 for checking a detailed inspection result corresponding to “COMPANY B'S FLIER” in the inspection result list 401 on the list screen 400 shown in FIG. 4A. The detailed check screen 410 is a screen on which a detailed inspection result for an inspected job may be checked in a case where a result check link for the inspected job in the inspection result list 401 included in the list screen 400 is selected. FIG. 4B shows, as an example, the detailed check screen 410 in a case where 16 copies of a 5-page print job, that is, a total of 80 pages, are printed, and two pages out of the 80 pages are “NO GOOD.” The detailed check screen 410 includes a thumbnail 411 of a scanned image corresponding to “NO GOOD” printed material, a summary result 412 of inspection processing, a “NO GOOD” list 413 in which information indicating “NO GOOD” printed materials is listed, an image diagnosis execution button 414, and a close button 415.

The thumbnail 411 displays a reduced image of a scanned image of the front or back of a sheet (printed material) of which inspection result is “NO GOOD.” In a case where the inspection results of a plurality of sheets are “NO GOOD,” a user may press a selection button arranged below the thumbnail 411 to display a thumbnail corresponding to the scanned image of another sheet of which inspection result is “NO GOOD” on the detailed check screen 410. The summary result 412 displays information on a summary of the inspection results of an inspected job. For example, the summary result 412 displays information indicating the number of inspected pages, the number of pages of which inspection results are “NO GOOD,” the ratio of printed materials of which inspection results are “NO GOOD” (“NO GOOD” rate), and the number of pages printed or read with an error. In addition to the above information, the summary result 412 also displays information indicating a breakdown of factors in defects in a page of which inspection result is “NO GOOD.” Specifically, for example, the summary result 412 displays information indicating the numbers of vertical misalignments, horizontal misalignments, dot-like stains, and streak-like stains as a breakdown of factors in defects.

The “NO GOOD” list 413 displays information on the page number of a “NO GOOD” sheet (printed material) in an entire selected inspected job and information on a copy number indicating which copy includes the “NO GOOD” sheet in the entire inspected job. In addition to the above information, the “NO GOOD” list 413 also displays page number information indicating which page is “NO GOOD” in the copy, and side number information indicating which side is “NO GOOD,” the front or back of the sheet. In addition to the above information, the “NO GOOD” list 413 further displays information indicating a breakdown of factors in defects in the page of which inspection result is “NO GOOD” in a binary manner, “OK” or “NO GOOD.” In addition to the above information, the “NO GOOD” list 413 displays information indicating the date and time of inspection and information indicating a check link for transitioning to a screen for checking a scanned image corresponding to “NO GOOD” printed material. In a case where a user presses the check link in the “NO GOOD” list 413, a scanned image corresponding to a page of which inspection result is “NO GOOD” is displayed, and the user may check the printing state of a sheet corresponding to the scanned image.

The image diagnosis execution button 414 is a UI component for transitioning to an execution screen that gives an instruction to execute image diagnosis, and in a case where a user presses the image diagnosis execution button 414, an execution screen for executing image diagnosis is displayed. The close button 415 is a UI component for hiding the detailed check screen 410, and in a case where a user presses the close button 415, the list screen 400 displayed before the transition to the detailed check screen 410 is displayed.

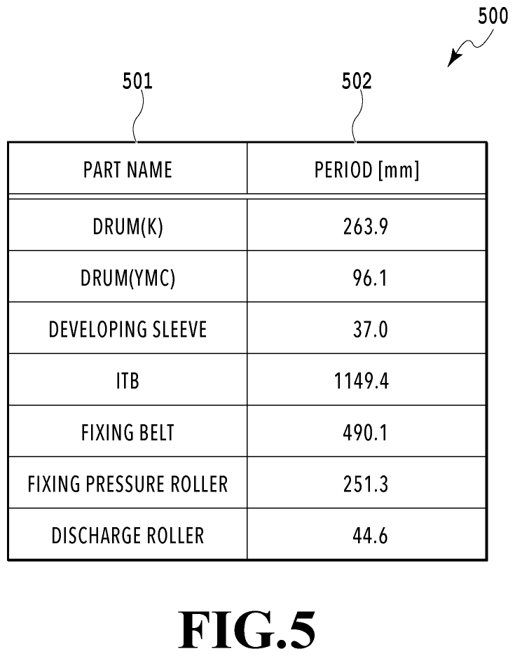

FIG. 5 is a diagram showing, as a list (hereinafter referred to as “period list 500”), an example of information according to the first embodiment, indicating the period of each consumable part in the printing device 107, that is, the length of one outer circumference of a rotation part. Data on the period list 500 is assumed to be stored in advance in the HDD 256 of the inspection device 109. A part name 501 indicates a specific name that may uniquely identify a consumable part, and a period 502 indicates the period of each consumable part (the length of one outer circumference of a rotation part) in millimeters (mm). The inspection device 109 first identifies a periodic image defect based on scanned image data obtained by reading printed material by the image capturing unit 240. The inspection device 109 then identifies a consumable part that causes the image defect by comparing the period of the identified image defect with the period of each consumable part in the period list 500.

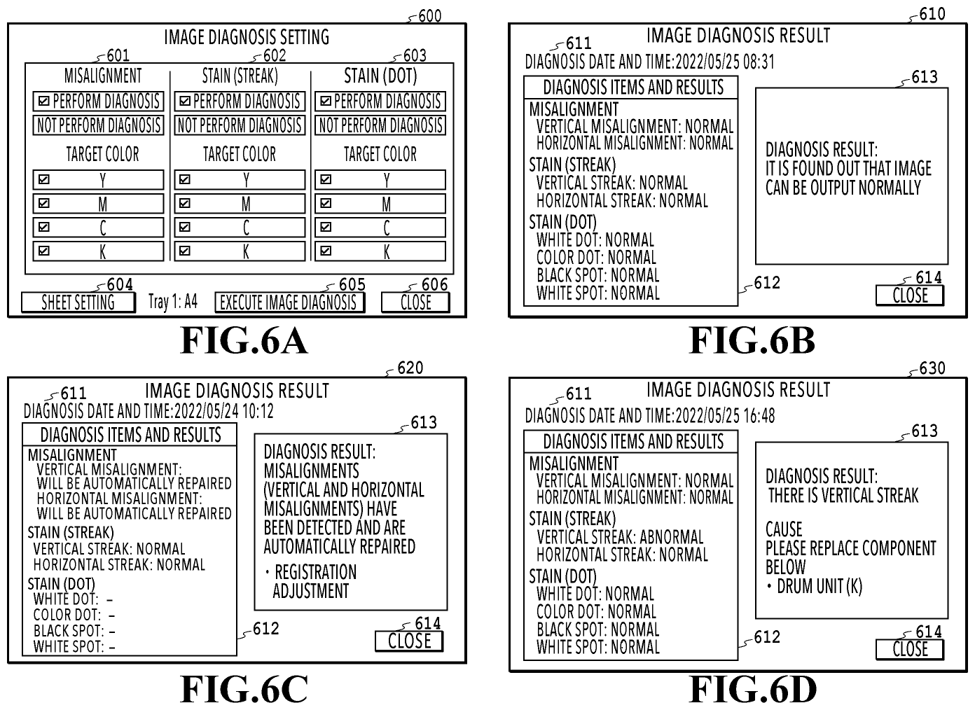

FIGS. 6A to 6D are diagrams showing an example of a screen relating to image diagnosis and displayed on the display unit 241 by the inspection device 109 according to the first embodiment. Hereinafter, it is assumed that the screen is displayed on the display unit 241. However, the display output destination of the screen is not limited to the display unit 241. For example, the screen may be displayed on the display 225 of the printing device 107, the display 212 of the external controller 102, or the like.

FIG. 6A shows an example of an execution screen 600 for giving instructions to make setting on image diagnosis and execute the image diagnosis. The execution screen 600 includes diagnosis setting areas 601 to 603 for setting a target for image diagnosis, and a sheet setting button 604 for accepting an instruction to transition to a screen not shown in FIGS. 6A to 6D for setting information on a sheet to be a target for image diagnosis. The execution screen 600 also includes an image diagnosis execution button 605 for accepting an instruction to execute image diagnosis and a close button 606 for hiding the execution screen 600 and accepting transition to the screen before the transition to the execution screen 600.

The diagnosis setting areas 601 to 603 are areas for designating a target for image diagnosis for each factor in an image defect. The diagnosis setting area 601 is an area for setting whether to perform an image diagnosis of an image of which defect is caused by a misalignment. Similarly, the diagnosis setting area 602 is an area for setting whether to perform an image diagnosis of an image of which defect is caused by a streak-like stain, and the diagnosis setting area 603 is an area for setting whether to perform an image diagnosis of an image of which defect is caused by a dot-like stain. It is possible to set whether to perform image diagnosis for each factor in an image defect, and whether to perform image diagnosis is selected in an alternative manner. For a factor for which setting has been made to perform image diagnosis, a target color for image diagnosis may be set. For the target color, a color used for printing may be set individually, and in the example shown in FIG. 6A, toner colors corresponding to Y, M, C, and K, respectively may be set individually. For example, the diagnosis setting area 601 includes buttons corresponding to respective toner colors, and in a case where a button is pressed once, a color corresponding to the button is in the state of being a target for image diagnosis, and in a case where the button is pressed again, the color is in the state of not being the target.

The sheet setting button 604 is a UI component for accepting transition to a sheet setting screen not shown in any of FIGS. 6A to 6D for setting information on a sheet to be a target for image diagnosis, and in a case where a user presses the sheet setting button 604, the sheet setting screen is displayed. The user may set information on a sheet to be a target for image diagnosis on the sheet setting screen, and the set information is displayed, for example, near the sheet setting button 604 (on the left of the sheet setting button 604 in FIG. 6A). FIG. 6A shows an example of setting sheet information in units of feed decks (feed trays) that store sheets to be used for printing and shows a state where an A4 size is set for a tray 1.

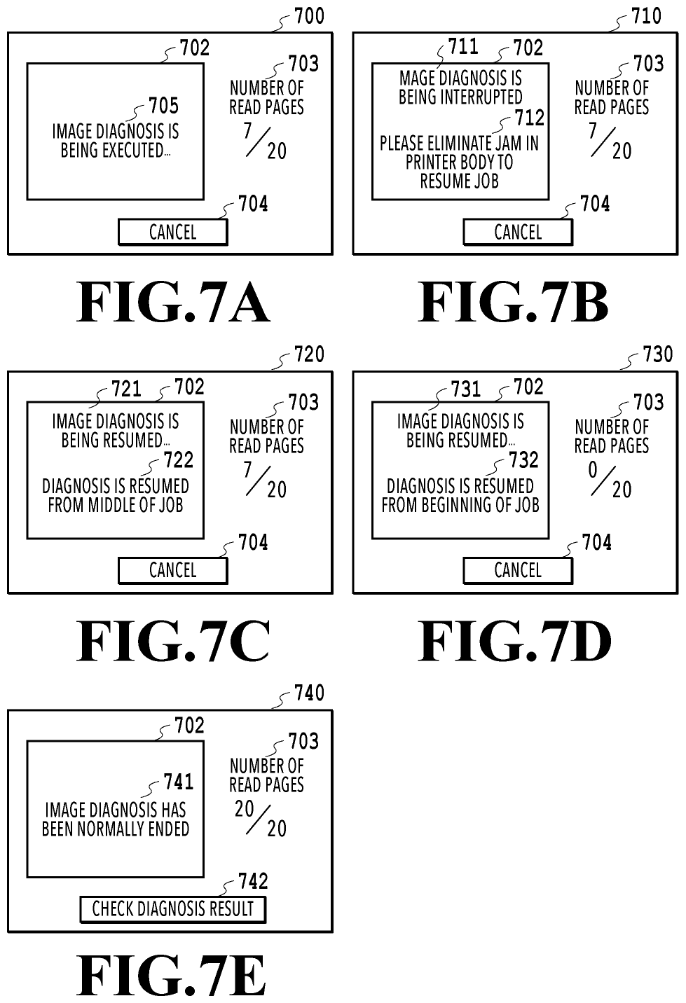

The image diagnosis execution button 605 is a UI component for accepting an instruction to execute image diagnosis. In a case where a user presses the image diagnosis execution button 605, the inspection device 109 starts executing an image diagnosis job based on information set in the diagnosis setting areas 601 to 603 and sheet information set on the sheet setting screen. In a case where the image diagnosis execution button 605 is pressed, the inspection device 109 starts executing an image diagnosis job and displays a screen 700 during execution, which will be described later with reference to FIGS. 7A to 7E.

Specifically, in a case where the image diagnosis execution button 605 is pressed, the inspection device 109 first instructs the printing device 107 to print a diagnostic chart group formed of a plurality of diagnostic charts. Next, the inspection device 109 sequentially captures a plurality of printed materials on which the plurality of diagnostic charts are printed in succession and acquires a plurality of pieces of scanned image data corresponding to the plurality of respective diagnostic charts. The inspection device 109 then diagnoses an image formed on the printed materials by comparing the acquired scanned image data with reference image data. That is, the image diagnosis job is a series of steps including the processes of printing a diagnostic chart, capturing printed material on which the diagnostic chart is printed, and diagnosing a scanned image obtained by the capturing. The close button 606 is a UI component for hiding the execution screen 600, and in a case where a user presses the close button 606, the execution screen 600 is hidden without executing image diagnosis, and the screen displayed before the transition to the execution screen 600 is displayed.

FIGS. 6B, 6C, and 6D show examples of diagnosis result screens 610, 620, and 630 for displaying information indicating image diagnosis execution results. The diagnosis result screen 610 shown in FIG. 6B is an example of a screen in a case where the result of image diagnosis shows that all scanned images corresponding to respective printed materials are normal. The diagnosis result screen 610 includes areas for displaying information indicating a diagnosis date and time 611, an image diagnosis result 612 for each diagnosis item, and a comprehensive image diagnosis result 613 and also includes a close button 614.

The area for displaying information indicating the diagnosis date and time 611 displays information indicating the date and time of execution of image diagnosis and finalization of a diagnosis result. The area for displaying information indicating the image diagnosis result 612 for each diagnostic item displays information indicating a detailed diagnosis result for each diagnostic item that is a target for image diagnosis. Here, the diagnostic item is an item for each factor in an image defect set in the diagnosis setting areas 601, 602, and 603. Hereinafter, it is assumed that as an image diagnosis result for each diagnostic item, “NORMAL,” “ABNORMAL,” “RECOVERY WILL BE AUTOMATICALLY PERFORMED,” or “−” indicating that the item is not a target for diagnosis is displayed. The area for displaying information indicating the image diagnosis result 613 displays a comprehensive image diagnosis result based on the image diagnosis result 612 for each diagnostic item. This area displays, for example, a specific message that may be easily recognized by a user. The close button 614 is a UI component for hiding the diagnosis result screen 610, and in a case where a user presses the close button 614, the diagnosis result screen 610 is hidden and the screen displayed before the transition to the diagnosis result screen 610 is displayed.

The diagnosis result screen 620 shown in FIG. 6C is an example of a screen in a case where an image defect due to a misalignment has been detected in a scanned image corresponding to at least a portion of printed materials as a result of image diagnosis and where the misalignment is automatically repaired. The diagnosis result screen 620 includes areas for displaying information indicating the diagnosis date and time 611, the image diagnosis result 612 for each diagnosis item, and the comprehensive image diagnosis result 613 and also includes the close button 614, as in the diagnosis result screen 610 shown in FIG. 6B. The area for displaying information indicating the image diagnosis result 612 for each diagnosis item on the diagnosis result screen 620 displays the character string “RECOVERY WILL BE AUTOMATICALLY PERFORMED” in items for vertical and horizontal misalignments which are items for targets for automatic recovery. Further, information indicating that the automatic recovery has been performed is displayed in the area for displaying information indicating the comprehensive image diagnosis result 613.

The diagnosis result screen 630 shown in FIG. 6D is an example of a screen in a case where an image defect due to a streak-like stain extending vertically is detected in a scanned image corresponding to at least a portion of printed materials as a result of image diagnosis. The diagnosis result screen 630 includes areas for displaying information indicating the diagnosis date and time 611, the image diagnosis result 612 for each diagnosis item, and the comprehensive image diagnosis result 613 and also includes the close button 614, as in the diagnosis result screen 610 shown in FIG. 6B. The area for displaying information indicating the image diagnosis result 612 for each diagnosis item displays the character string “ABNORMAL” in an item for a streak-like stain extending vertically. Further, the area for displaying information indicating the comprehensive image diagnosis result 613 displays information indicating an item for diagnosis in which an image defect has been detected, and information indicating a cause of the image defect and a method to take measures against the defect.

FIGS. 7A to 7E are diagrams showing examples of a screen displayed on the display unit 241 by the inspection device 109 during execution of an image diagnosis job according to the first embodiment. Hereinafter, it is assumed that the screen is displayed on the display unit 241. However, the display output destination of the screen is not limited to the display unit 241. For example, the screen may be displayed on the display 225 of the printing device 107, the display 212 of the external controller 102, or the like.

FIG. 7A shows an example of a screen (hereinafter referred to as “screen during execution”) 700 displayed during execution of an image diagnosis job. In a case where the image diagnosis execution button 605 on the execution screen 600 is pressed, the screen 700 during execution shown in FIG. 7A is displayed on the display unit 241 as execution of an image diagnosis job is started by the inspection device 109. The screen 700 during execution includes a state display area 702 where information indicating the state of an image diagnosis job is displayed, a progress display area 703 where information indicating the progress of the image diagnosis job is displayed, and a cancellation button 704 for accepting an instruction to cancel the image diagnosis job.

The state display area 702 displays information indicating the state of an image diagnostic job under execution, and in a case where the image diagnostic job is executed normally, information such as a character string 705 indicating that the image diagnostic job is under execution is displayed as in the screen example shown in FIG. 7A. The progress display area 703 displays information indicating the progress of the image diagnostic job. The screen example shown in FIG. 7A shows that in a case where the total number of sheets of a diagnostic chart in the image diagnostic job is 20, printing of the diagnostic chart from first to seventh pages out of 20 pages and capturing (reading) of printed material on which the diagnostic chart is printed have been completed. Each time the reading of each page is completed, a number indicating the number of pages that have been read in the progress display area 703 is incremented. The cancellation button 704 is a UI component for accepting the cancellation of an image diagnostic job, and a user may cancel the image diagnostic job under execution midway by pressing the cancellation button 704.

FIG. 7B shows an example of a screen (hereinafter referred to as “screen during interruption”) 710 displayed in a case where the image diagnostic job is interrupted due to an abnormality in the image forming apparatus 101. The screen 710 during interruption shown as an example in FIG. 7A is an example of a screen in a case where the image diagnostic job is interrupted due to a paper jam that has occurred after reading of the seventh page of the diagnostic chart. The screen 710 during interruption includes the state display area 702, the progress display area 703, and the cancellation button 704. In a case where the image diagnostic job is interrupted, the state display area 702 of the screen 710 during interruption displays a character string 711 indicating that the job is being interrupted and a character string 712 indicating an action that the user may take to resume the image diagnostic job, as in the screen example shown in FIG. 7B. Specifically, in the screen example shown in FIG. 7B, since the image diagnostic job is interrupted due to a paper jam in the image forming apparatus 101, the state display area 702 displays a message urging a user to eliminate the paper jam as the character string 712.

FIGS. 7C and 7D show examples of screens (hereinafter referred to as “resume screens”) 720, 730 displayed in a case where the interrupted image diagnostic job is resumed. Specifically, FIG. 7C is an example of a screen displayed in a case where the interrupted image diagnostic job is resumed continuously from a middle page of the diagnostic chart at the time of interruption. On the other hand, FIG. 7D is an example of a screen displayed in a case where image diagnosis is redone for the interrupted image diagnostic job from the first page of the diagnostic chart. The resume screens 720, 730 shown in FIGS. 7C and 7D, respectively, are displayed in a case where the cause of the interruption of the image diagnostic job is eliminated and the interrupted image diagnostic job is resumed. Specifically, for example, in a case where the user eliminates the paper jam in a state where the screen 710 during interruption shown in FIG. 7B is displayed, the interrupted image diagnostic job is resumed and the resume screen 720 or the resume screen 730 is displayed.

The resume screens 720, 730 each include the state display area 702, the progress display area 703, and the cancellation button 704. As in the screen example shown in FIG. 7C, the state display area 702 of the resume screen 720 displays a character string 721 indicating that the image diagnostic job is resumed and a character string 722 indicating that the image diagnostic job is resumed from a middle page of the diagnostic chart. As shown in the screen example in FIG. 7D, the state display area 702 of the resume screen 730 displays a character string 731 indicating that the image diagnostic job is resumed and a character string 732 indicating that the image diagnostic job is resumed from the first page of the diagnostic chart.

In a case where the image diagnosis job is resumed from the first page of the diagnostic chart, the number indicating the number of pages that have been read in the progress display area 703 on the resume screen 730 returns to 0.

The resume screens 720, 730 shown in FIGS. 7C and 7D, respectively, are screens displayed immediately after the image diagnostic job is resumed. Thus, at a predetermined time, such as the time of the first page being read after the image diagnostic job is resumed, the resume screens 720 and 730 are replaced with the screen 700 during execution shown in FIG. 7A as an example.

FIG. 7E shows an example of a screen (hereinafter referred to as “completion screen”) 740 displayed in a case where the image diagnosis job is completed. The completion screen 740 includes the state display area 702, the progress display area 703, and a diagnosis result check button 742. The completion screen 740 is displayed in a case where the reading of all pages of the diagnostic chart is completed. Thus, in the screen example shown in FIG. 7E, the number of pages that have been read in the progress display area 703 is incremented to 20, and the state display area 702 displays a character string 741 indicating that the image diagnosis job has been normally completed. The diagnosis result check button 742 is a UI component for accepting an instruction to transition to a screen (diagnosis result screen) for displaying information indicating a diagnosis result of the image diagnosis job. In a case where the user presses the diagnosis result check button 742, any of the diagnosis result screens shown as examples in FIG. 6B to FIG. 6D is displayed.

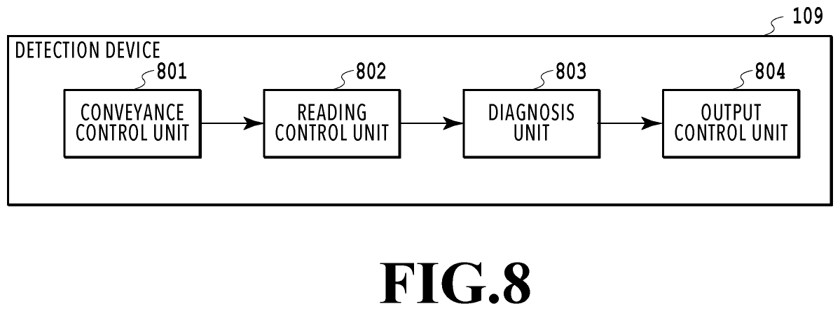

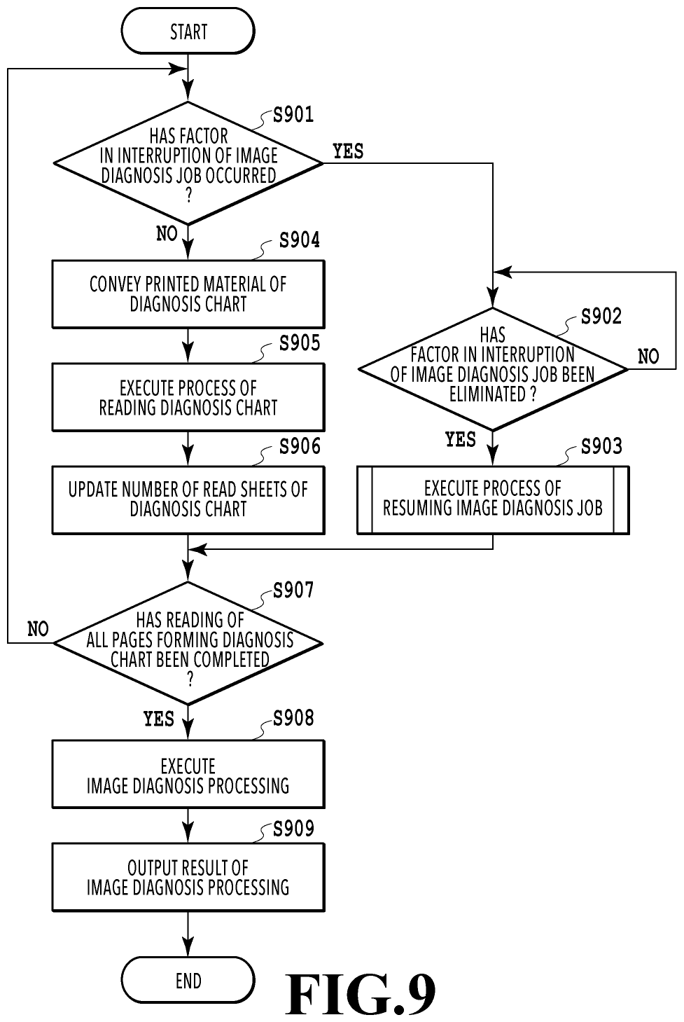

FIG. 8 is a block diagram showing an example of the functional configuration of the inspection device 109 according to the first embodiment. The inspection device 109 includes, as functional constituents, a conveyance control unit 801, a reading control unit 802, a diagnosis unit 803, and an output control unit 804. Each unit of the inspection device 109 as a functional constituent is implemented by the CPU 238 reading out a predetermined control program from the HDD 256, expanding the program into the memory 239, and executing the program.

FIG. 9 is a flowchart showing an example of a processing flow in the inspection device 109 according to the first embodiment. In the following description, “S” at the beginning of each reference symbol indicates a step. A series of steps in the flowchart is implemented by the CPU 238 of the inspection device 109 expanding a control program read from the HDD 256 into the memory 239 and executing the program. The process in the flowchart is started in a case where the inspection device 109 receives an instruction from a user to start executing image diagnosis processing, and an instruction to start printing a diagnostic chart formed of a plurality of pages is transmitted from the external controller 102 to the printing device 107. Printed material in which an image of the diagnostic chart is printed on each page by the printing device 107 is output from the printing device 107 and conveyed to the inspection device 109 via the inserter 108.

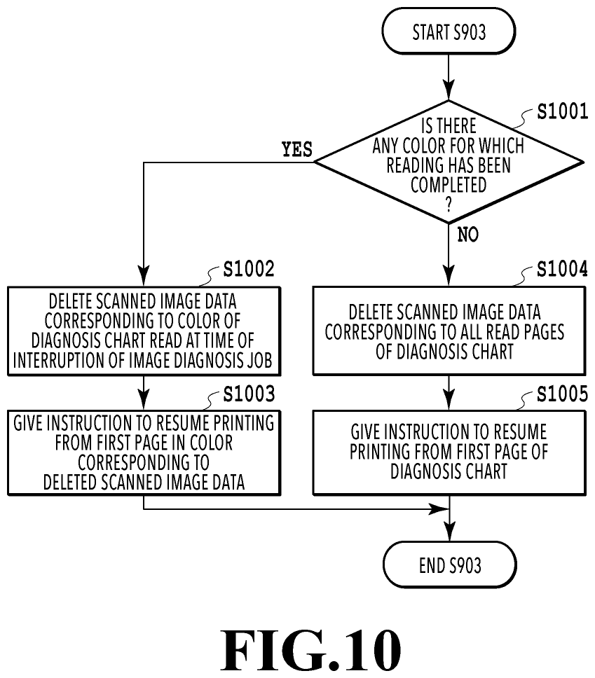

First, in S901, the conveyance control unit 801 determines whether a factor in interruption of an image diagnosis job, such as a paper jam, has occurred. If it is determined in S901 that the factor in interruption of the image diagnosis job has occurred, in S902, the conveyance control unit 801 determines whether the factor in interruption of the image diagnosis job has been eliminated. If it is determined in S902 that the factor in interruption of the image diagnosis job has not been eliminated, the conveyance control unit 801 repeatedly executes S902 until it is determined in S902 that the factor in interruption of the image diagnosis job has been eliminated. If it is determined in S902 that the factor in interruption of the image diagnosis job has been eliminated, in S903, the inspection device 109 executes a process of resuming the image diagnosis job. The process of resuming the image diagnosis job in S903 will be described later in detail with reference to FIG. 10,

If it is determined in S901 that no factor in interruption of the image diagnosis job has occurred, in S904, the conveyance control unit 801 conveys printed material of a diagnostic chart output from the printing device 107 to the image capturing unit 240. From the printing device 107, pages of the diagnostic chart corresponding to respective diagnostic items specified by a user on the execution screen 600 are repeatedly output by the number of colors for which image diagnosis is to be executed. In a case where a plurality of colors are designated on the execution screen 600, pages of the diagnostic chart having the same content are repeatedly output in the order of, for example, Y, M, C, and K. After S904, in S905, the reading control unit 802 controls the image capturing unit 240 to execute a process of reading the diagnostic chart and acquires scanned image data obtained by the reading. In S906, the reading control unit 802 then updates information indicating the number of sheets that have been read of the diagnostic chart and holds the updated information in the memory 239.

Next, in S907, the reading control unit 802 determines whether the reading of all pages forming the diagnostic chart has been completed. If it is determined in S907 that the reading of all pages has not been completed, the inspection device 109 returns to S901 and repeatedly executes S901 to S907 until it is determined in S907 that the reading of all pages has been completed. If it is determined in S907 that the reading of all pages has been completed, in S908, the diagnosis unit 803 executes image diagnosis processing using a plurality of pieces of scanned image data acquired in S905. It should be noted that in a case where an image defect is detected in the image diagnosis processing in S908, the diagnosis unit 803 identifies a consumable part that has caused the image defect in S908. Specifically, the diagnosis unit 803 identifies the consumable part that has caused the image defect by comparing the period of the detected image defect with information in the period list 500 listing the period of each consumable part held in the HDD 256.

After S908, in S909, the output control unit 804 outputs the result of the image diagnosis processing in S908. For example, the output control unit 804 outputs information indicating the result to a storage device such as the HDD 256 and stores the information in the storage device. It should be noted that the output destination of the result and the method for outputting the result by the output control unit 804 are not limited to those described above. For example, the output control unit 804 may generate a screen (diagnosis result screen) that displays the result and output a video signal corresponding to the screen to the display unit 241, thereby displaying and outputting the result of the image diagnosis processing in S908. After S909, the inspection device 109 ends the process in the flowchart shown in FIG. 9.

FIG. 10 is a flowchart showing an example of the flow of a process of resuming an image diagnosis job in the inspection device 109 according to the first embodiment and is a flowchart showing an example of the flow of S903 shown in FIG. 9. The process in the flowchart is executed in a case where it is determined in S902 that the factor in interruption of the image diagnosis job has been eliminated. A series of steps in the flowchart is executed by the CPU 238 of the inspection device 109 expanding a control program read from the HDD 256 into the memory 239 and executing the program.

First, in S1001, in an image diagnosis job in which a plurality of colors are designated as targets for image diagnosis, the reading control unit 802 determines whether there is a color for which the reading of a diagnostic chart has been completed at the time of the diagnostic image job being interrupted. If it is determined in S1001 that there is a color for which the reading has been completed, the inspection device 109 executes S1002. Specifically, in this case, in S1002, the reading control unit 802 deletes, from the memory 239, scanned image data corresponding to a color for which the diagnostic chart is being read at the time of the interruption of the diagnostic image job, that is, a color for which the reading of the diagnostic chart has not been completed. At this time, the reading control unit 802 keeps holding the scanned image data corresponding to the color for which the reading of the diagnostic chart has been completed without deleting the data from the memory 239. After S1002, in S1003, the reading control unit 802 instructs the printing device 107 to resume printing from the first page in the color corresponding to the scanned image data deleted in S1002 in the diagnostic chart and resumes the interrupted diagnostic image job.

If it is determined in S1001 that there is no color for which the reading has been completed, in S1004, the reading control unit 802 deletes, from the memory 239, scanned image data corresponding to all pages that have been read of the diagnostic chart. After S1004, in S1005, the reading control unit 802 instructs the printing device 107 to resume printing of the diagnostic chart from the first page and resumes the job from the beginning of the image diagnosis job. After S1003 or S1005, the inspection device 109 ends the process in the flowchart shown in FIG. 10, i.e., S903 shown in FIG. 9.

The inspection device 109 configured as above makes it possible to detect an image defect that occurs periodically in a case where an interrupted image diagnosis job is resumed even in a case where the continuity of rotation of a consumable part is interrupted due to the interruption of the image diagnosis job. In the case of performing image diagnosis for a plurality of colors, by resuming the image diagnosis job from the first page of a diagnostic chart corresponding to a color at the time of the interruption of the image diagnosis job, the inspection device 109 also makes it possible to reduce the number of printed sheets of the diagnostic chart after the resumption. As a result, it is possible to reduce the number of sheets and the amount of toner used to print the diagnostic chart after the resumption of the image diagnosis job. It is also possible to shorten time required to print the diagnostic chart after the resumption of the image diagnosis job, and thereby shorten time required for image diagnosis processing.

### OTHER EMBODIMENTS

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, even in a case where a print job is interrupted, it is possible to determine whether there is a periodic image defect across a plurality of scanned images.

While the present disclosure has described exemplary embodiments, it is to be understood that some embodiments of the disclosure are not limited to the disclosed exemplary embodiments. The scope of the following claims is to be accorded the broadest interpretation so as to encompass all such modifications and equivalent structures and functions.

This application claims priority to Japanese Patent Application No. 2023-159979, which was filed on Sep. 25, 2023, and which is hereby incorporated by reference wherein in their entirety.

What is claimed is:

1. An image forming apparatus comprising an image forming unit configured to form a pattern image on a printing material, the image forming apparatus comprising:
one or more controllers including one or more processors; and
one or more memories, the one or more controllers configured to:
acquire data on a scanned image obtained by reading the printing material on which the pattern image is formed;
detect a periodic image defect from the data;
identify a component of the image forming apparatus that has caused the image defect based on a period of the detected image defect; and
in a case where a job of forming the pattern image on a plurality of printing materials is interrupted, resume forming the pattern image from a beginning of the job.

2. The image forming apparatus according to claim 1, wherein
the one or more controllers are configured further to acquire the data corresponding to the job from the beginning of the data again in a case where the job is interrupted.

3. The image forming apparatus according to claim 1, wherein
the job is a job of forming a pattern image in a single color on each piece of the plurality of printing materials.

4. The image forming apparatus according to claim 1, wherein
the job is a job of forming on the printing materials a plurality of the pattern images corresponding to a plurality of respective colors.

5. The image forming apparatus according to claim 4, wherein
the one or more controllers are configured further to detect the image defect in the plurality of respective colors based on a plurality of the scanned images obtained by reading a plurality of the printing materials on which a plurality of the pattern images corresponding to the plurality of respective colors are formed.

6. The image forming apparatus according to claim 1, wherein
the one or more controllers are configured further to based on information indicating a length between two or more of the image defects in one of the scanned images, or a length between two or more of the image defects in continuous two or more of the scanned images, and information indicating a length of an outer circumference in a rotation direction of components of the image forming apparatus, identify the component of the image forming apparatus that has caused the image defects.

7. The image forming apparatus according to claim 1, wherein
the one or more controllers are configured further to detect at least of a dot-like or streak-like stain and a misalignment of an image forming position as the image defect.

8. The image forming apparatus according to claim 1, wherein
the one or more controllers are configured further to set whether to identify the image defect for each color of a plurality of colors.

9. The image forming apparatus according to claim 1, wherein
the one or more controllers are configured further to acquire the data on the scanned image by reading the printing material which is conveyed from the image forming apparatus and in which an image is formed.

10. The image forming apparatus according to claim 1, wherein
the one or more controllers are configured further to output to a display device a screen indicating a result, based on the scanned image, of identifying the component of the image forming apparatus that has caused the image defect.

11. The image forming apparatus according to claim 1, wherein
the one or more controllers are configured further to delete the data on the scanned image been reading in a case where the job is interrupted.

12. An image forming apparatus comprising an image forming unit configured to form a pattern image for each color on a plurality of printing materials, the image forming apparatus comprising:
one or more controllers including one or more processors; and
one or more memories, the one or more controllers configured to:
acquire data on a scanned image obtained by reading a printing material on which the pattern image is formed;
detect a periodic image defect from the data;
identify a component of the image forming apparatus that has caused the image defect based on a period of the detected image defect; and
in a case where a job of forming the pattern image is interrupted, resume the job from the pattern image at a beginning in a color of the pattern image been reading at a time of interruption of the job.

13. A method of controlling an image forming apparatus comprising an image forming unit configured to form a pattern image on a printing material, the method comprising the steps of:
acquiring data on a scanned image obtained by reading the printing material on which the pattern image is formed;
detecting a periodic image defect from the data;
identifying a component of the image forming apparatus that has caused the image defect based on a period of the detected image defect; and
in a case where a job of forming the pattern image on a plurality of printing materials is interrupted, resuming forming the pattern image from a beginning of the job.

14. A method of controlling an image forming apparatus comprising an image forming unit configured to form a pattern image for each color on a plurality of printing materials, the method comprising the steps of:
acquiring data on a scanned image obtained by reading a printing material on which the pattern image is formed;
detecting a periodic image defect from the data;
identifying a component of the image forming apparatus that has caused the image defect based on a period of the detected image defect; and
in a case where a job of forming the pattern image is interrupted, resuming the job from the pattern image at a beginning in a color of the pattern image been reading at a time of interruption of the job.
